(19) United States
(12) Patent Application Publication
(10) Pub. No.: US 2022/0010604 A1
(43) Pub. Date: Jan. 13, 2022

(54) PANEL-AND-FRAME ASSEMBLY

(71) Applicant: HSIAO-WEN HSIEH, Taichung (TW)

(72) Inventor: HSIAO-WEN HSIEH, Taichung (TW)

(21) Appl. No.: 16/924,185

(22) Filed: Jul. 9, 2020

(51) Int. Cl. E05D 1/00

(52) U.S. Cl. CPC E05D 1/00; E05D 2700/02

(57) ABSTRACT

A panel-and-frame assembly includes panel pivotally connected to an integrated frame. The panel includes a leaf extending on an external side and an axle extending on and along an edge of the leaf The leaf is made with a width smaller than a diameter of the axle. The integrated frame includes a channel extending in an internal side of the integrated frame and including a slit in communication with a recess. The recess receives the axle. The slit is made with a width smaller than the diameter of the axle to keep the axle in the recess. The width of the slit is larger than thickness of the leaf to allow pivoting of the panel relative to the integrated frame between an opening position and a closing position.

### BACKGROUND OF INVENTION

### 1. Field of Invention

The present invention relates to a panel and, more particularly, to a panel-and-frame assembly.

### 2. Related Prior Art

Referring to FIG. 7, a building includes a wall 90 made with a window 91 for letting light and air into the building. A panel 93 is connected to the wall 90 by hinges 92 so that the panel 93 is movable between an opening position and closing position. Each of the hinges 92 includes a first portion connected to the wall 90 by screws 94 and a second portion connected to the panel 93 by other screws 94. The use of this panel 93 for on widow 91 on the wall 90 is not without any problems. Firstly, the screws 94 however tend to get slack because of the repeated pivoting of the panel 93 relative to the wall 90. Secondly, the installation of the panel 93 with the hinges 92 increases labor cost. Thirdly, it requires careful measurement and carpentry skills to use the hinges 92 to properly mount the panel 93 and have them function correctly.

The present invention is therefore intended to obviate or at least alleviate the problems encountered in prior art.

### SUMMARY OF INVENTION

It is the primary objective of the present invention to provide a convenient and reliable panel-and-frame assembly.

To achieve the foregoing objective, the panel-and-frame assembly includes a panel pivotally connected to an integrated frame. The panel includes a leaf extending on an external side and an axle extending on and along an edge of the leaf The leaf is made with a width smaller than a diameter of the axle. The integrated frame includes a channel extending in an internal side of the integrated frame and including a slit in communication with a recess. The recess receives the axle. The slit is made with a width smaller than the diameter of the axle to keep the axle in the recess. The width of the slit is larger than thickness of the leaf to allow pivoting of the panel relative to the integrated frame between an opening position and a closing position.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a panel-and-frame assembly according to the first embodiment of the present invention;

FIG. 2 is a partial cut-away view of a panel of the panel-and-frame assembly shown in FIG. 1;

FIG. 3 is a partial cut-away view of an integrated frame of the panel-and-frame assembly shown in FIG. 1;

FIG. 4 is a partial cross-sectional view of the panel-and-frame assembly shown in FIG. 1;

FIG. 5 is a partial cross-sectional view of the panel-and-frame assembly in another position than shown in FIG. 4;

FIG. 6 is a partial cut-away view of a panel of a panel-and-frame assembly according to the second embodiment of the present invention; and

FIG. 7 is a perspective view of a conventional panel attached to a wall of a building.

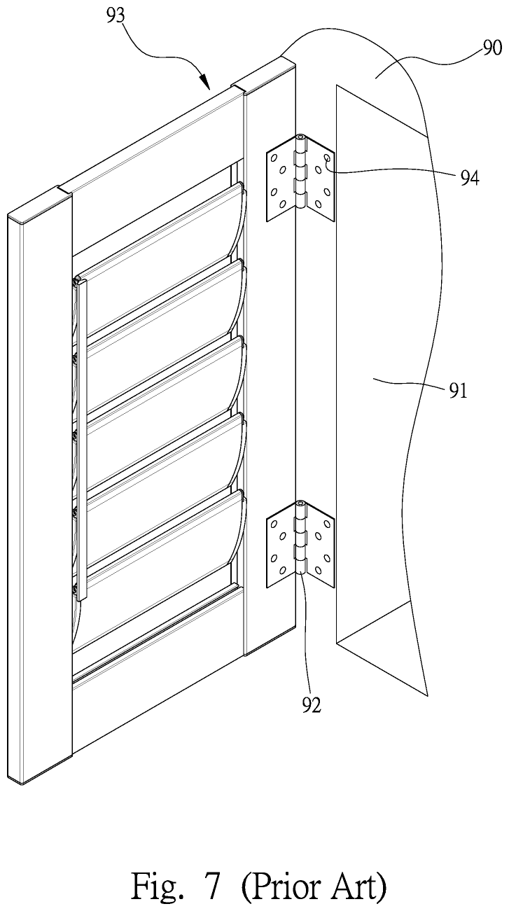

### DETAILED DESCRIPTION OF EMBODIMENTS

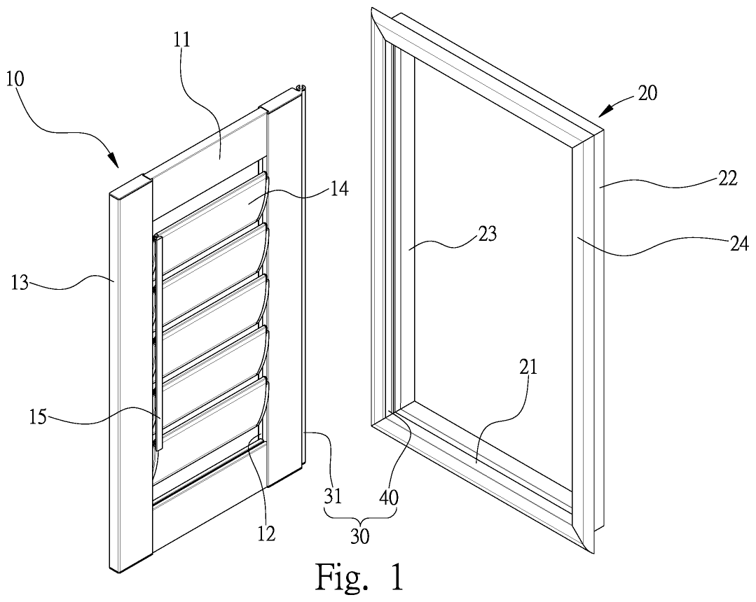

Referring to FIG. 1, a panel-and-frame assembly includes a panel 10, an integrated frame 20 and a pivotal connector 30 for pivotally connecting the panel 10 to the integrated frame 20 according to a first embodiment of the present invention. Both of the panel 10 and the integrated frame 20 are made by extrusion of a suitable material.

The panel 10 includes a panel frame 11, louvers 14 and a linking element 15. The louvers 14 extend parallel to one another and are pivotally connected to an internal side 12 of the panel frame 11. The linking element 15 is used to link the louvers 14 to one another. When each of the louvers 14 is pivoted relative to the panel frame 11, all of the louvers 14 are pivoted by a same angle because they are linked to one another by the linking element 15. The panel frame 11 is formed with an external side 13 as an external side of the entire panel 10.

The integrated frame 20 is a rectangular element. The integrated frame 20 is made with an internal side 21 in compliance with the external side 13 of the panel frame 11. The integrated frame 20 is formed with a restraining portion 23 extending from and along the internal side 21. The integrated frame 20 is formed with a flange 24 extending from and along an external side 22.

The pivotal connector 30 includes a hollow axle 31 and a channel 40. The hollow axle 31 is part of the panel frame 11. The channel 40 is made in the integrated frame 20.

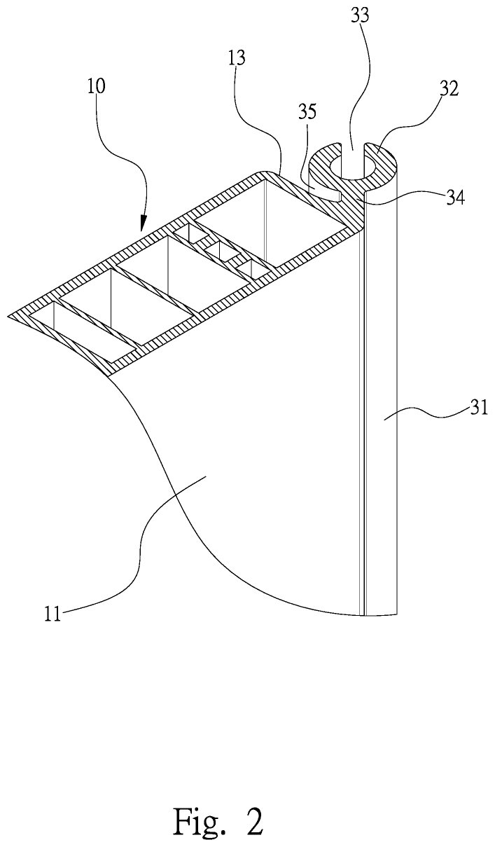

Referring to FIG. 2, the panel frame 11 is formed with a leaf 34 connected to the external side 13 at an end and connected to the hollow axle 31 at another end. The leaf 34 is slant, i.e., it extends at an angle relative to the panel frame 11 so that there is a groove 35 between the external side 13 of the panel frame 11 and the periphery of the hollow axle 31.

The hollow axle 31 is made with an external diameter larger than the thickness of the leaf 34. The hollow axle 31 includes a wall 32, an axial recess (not numbered) in the wall 32, and a slit 33 extending between and along two edges of the wall 32. The slit 33 is in communication with the axial recess in the wall 32 of the hollow axle 31. The slit 33 and the leaf 34 are located on two opposite portions of the periphery of the axle 31.

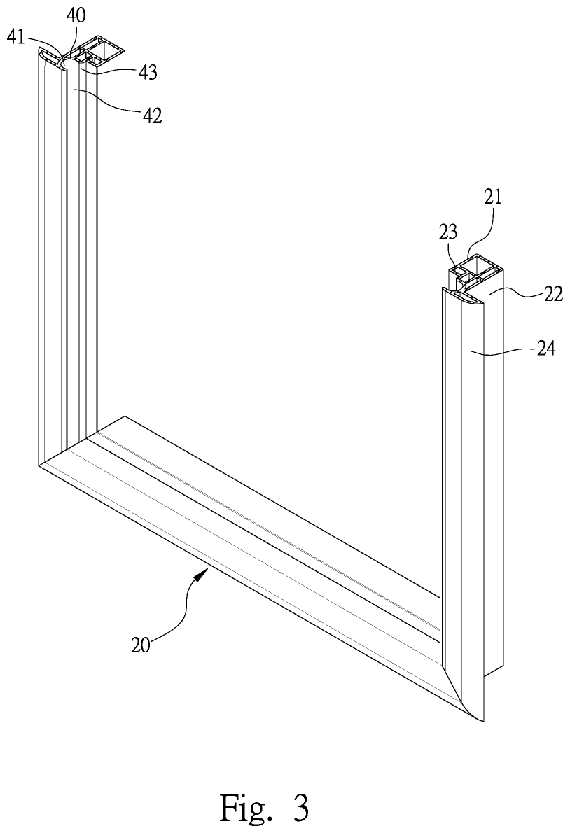

Referring to FIG. 3, the channel 40 extends in and along the internal side 21 of the integrated frame 20. The channel 40 consists of a recess 41 and a slit 42. The slit 42 extends between and along two edges of the channel 40. Thus, the slit 42 allows access to the recess 41. The recess 41 is semicircular when it is viewed in an axial direction. A width of the slit 42 is smaller than the diameter of the recess 41. In addition, a slant face 43 is formed on the internal side 21 of the integrated frame 20. The slant face 43 is located next to the slit 42. The slant face 43 extends at and along the first edge of the channel 40.

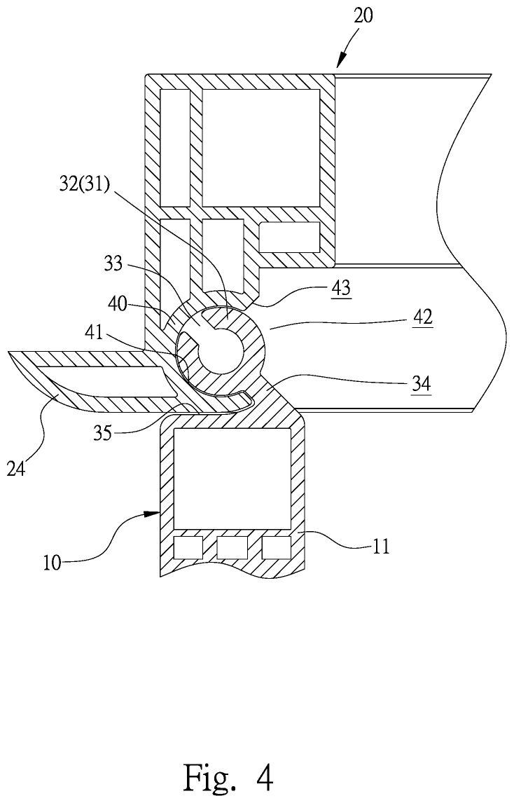

Referring to FIG. 4, the recess 41 receives the hollow axle 31.

The hollow axle 31 is pressed into the recess 41 via the slit 42. The slit 33 allows easy compression of the hollow axle 31, thereby rendering easy the pressing of the hollow axle 31 into the recess 41. The width of the slit 42 is smaller than the diameter of the periphery of the hollow axle 31 to keep the hollow axle 31 in the recess 41.

The width of the slit 42 is considerably larger than the thickness of the leaf 34 to allow considerable pivoting of the panel 10 relative to the integrated frame 20. The first and second edges of the channel 40 are used as limits for the pivoting of the panel 10 relative to the integrated frame 20.

Referring to FIG. 4, the panel 10 is in an opening position relative to the integrated frame 20. The groove 35 receives the second edge of the channel 40. The leaf 34 is abutted against the second edge of the channel 40.

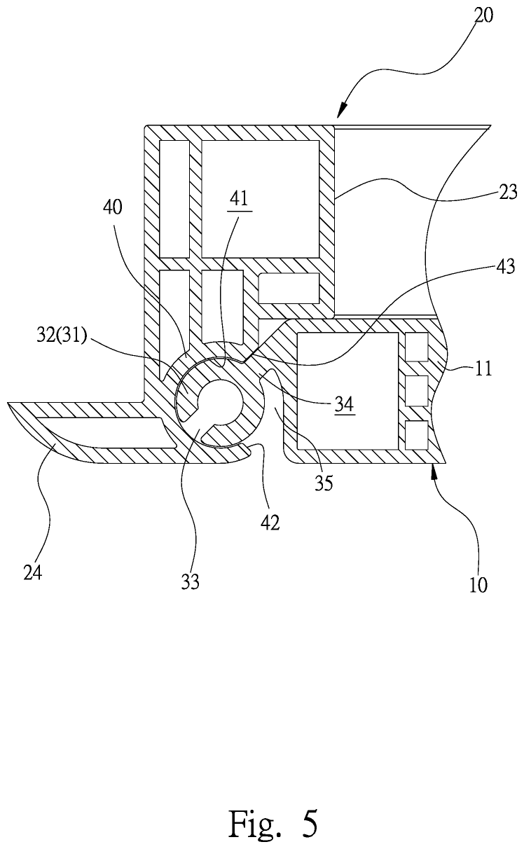

Referring to FIG. 5, the panel 10 is in a closing position relative to the integrated frame 20. The leaf 34 is abutted against the slant face 43, which is formed at the first edge of the channel 40. Now, the panel frame 11 extends parallel to the restraining portion 23. The slit 33 is located the recess 41.

To insert the hollow axle 31 into the channel 40, the slit 33 is aligned with the slit 42. Then, an adequate force is exerted on the hollow axle 31 against the integrated frame 20 to push the hollow axle 31 into the recess 41 via the slit 42.

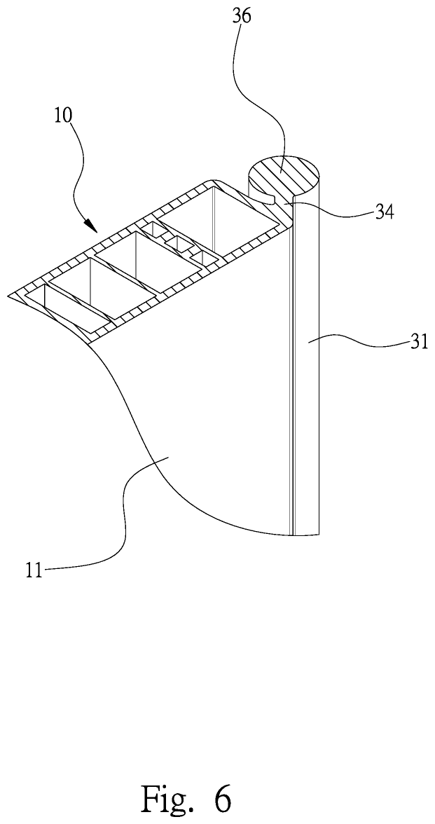

Referring to FIG. 6, there is shown a panel according to a second embodiment of the present invention. The second embodiment is identical to the first embodiment except for using a solid axle 36 instead of the hollow axle 31. In the second embodiment, it would be preferred that the hollow axle 31 is inserted into the recess 41 of the channel 40 in the second manner mentioned above.

The present invention has been described via the illustration of the embodiments. Those skilled in the art can derive variations from the embodiments without departing from the scope of the present invention.

Therefore, the embodiments shall not limit the scope of the present invention defined in the claims.

1. A panel-and-frame assembly comprising:
a panel comprising a leaf extending on an external side and an axle extending on and along an edge of the leaf, wherein the leaf is made with a width smaller than a diameter of the axle; and
an integrated frame comprising a channel extending in an internal side of the integrated frame and comprising a recess and a slit in communication with the recess;
wherein the axle is inserted in the recess to pivotally connect the panel to the integrated frame without having to use an external hinge;
wherein the slit is made with a width smaller than the diameter of the axle to keep the axle in the recess;
wherein the width of the slit is larger than thickness of the leaf to allow pivoting of the panel relative to the integrated frame between an opening position and a closing position.

2. The panel-and-frame assembly according to claim 1, wherein the leaf extends in a slant manner relative to the panel.

3. The panel-and-frame assembly according to claim 1, wherein the axle is a solid axle.

4. The panel-and-frame assembly according to claim 1, wherein the axle is a hollow axle.

5. The panel-and-frame assembly according to claim 4, wherein the hollow axle comprises a wall and a slit between two edges of the wall.

6. The panel-and-frame assembly according to claim 5, wherein the slit and the leaf are located on two opposite sides of the hollow axle.

7. A panel-and-frame assembly comprising:
a panel comprising a leaf extending on an external side, an axle extending on and along an edge of the leaf, and a groove between the panel and the leaf, wherein the leaf is made with a width smaller than a diameter of the axle; and
an integrated frame comprising a channel extending in an internal side of the integrated frame and comprising a recess and a slit in communication with the recess;
wherein the axle is inserted in the recess to pivotally connect the panel to the integrated frame without having to use an external hinge;
wherein the slit is made with a width smaller than the diameter of the axle to keep the axle in the recess;
wherein the width of the slit is larger than thickness of the leaf to allow pivoting of the panel relative to the integrated frame between an opening position and a closing position.

8. The panel-and-frame assembly according to claim 7, wherein the groove receives an edge of the panel extending along the channel when the panel is in the opening position relative to the integrated frame.

9. A panel-and-frame assembly comprising:
a panel comprising a leaf extending on an external side and an axle extending on and along an edge of the leaf, wherein the leaf is made with a width smaller than a diameter of the axle; and
an integrated frame comprising a channel extending in an internal side of the integrated frame and comprising a recess, a slit in communication with the recess, and a slant face extending by the slit;
wherein the axle is inserted in the recess to pivotally connect the panel to the integrated frame without having to use an external hinge;
wherein the slit is made with a width smaller than the diameter of the axle to keep the axle in the recess;
wherein the width of the slit is larger than thickness of the leaf to allow pivoting of the panel relative to the integrated frame between an opening position and a closing position;
wherein the slant face is abutted against the leaf when the panel is in the closing position relative to the integrated frame.
